(19) United States
(12) Patent Application Publication
(10) Pub. No.: US 2022/0269439 A1
(43) Pub. Date: Aug. 25, 2022

(54) ACCESS CONTROL FOR PROTECTION OF IN-MEMORY COMPUTATION

(71) Applicant: QUALCOMM Incorporated, San Diego, CA (US)

(72) Inventors: Dexter Tamio CHUN, San Diego, CA (US); Yanru LI, San Diego, CA (US)

(21) Appl. No.: 17/183,903

(22) Filed: Feb. 24, 2021

(51) Int. Cl. G06F 3/06; G06F 21/78

(52) U.S. Cl. CPC G06F 3/0659; G06F 21/78; G06F 3/0604; G06F 3/0679

(57) ABSTRACT

Protection of in memory or near memory computations may utilize a controller and an access path that is added through the control path to allow access control on the control path. In some examples, the memory compute request from the host may be intercepted and stopped. In addition, some examples the controller may synchronize the access control policy configuration on data path and control path, express the target address on the data bus instead of the address bus but instead is on the data bus, translate addresses using SWI groups, and the address may be filtered or blocked via the access controller.

### FIELD OF DISCLOSURE

This disclosure relates generally to in memory computations, and more specifically, but not exclusively, to access control for the protection of in memory computations.

### BACKGROUND

In conventional systems, all computational operations are performed by a processor with the operands and results stored or retrieved from an external memory. However, new memory capabilities are being developed by memory suppliers that will allow the performance of basic transform, math, and logical operations within the memory. To do so effectively, any access to memory must be supervised and protected by hardware.

In conventional systems, reads or writes to the external memory by the processor uses filters that allow/disallow the transaction by observing the read or write address and consulting a whitelist (or blacklist) of permissible (or impermissible) regions in the external memory for a read or write operation. This protection is necessary to prevent inter-process corruption, leakage, and security attacks. However, the new in-memory and near-memory computations cannot be protected using traditional methods of restricting memory access. Thus, there is a need to develop new methods and apparatus to protect external memory such that in/near memory computations may apply to existing digital memory structures or may extend to new analog cell memory structures.

Accordingly, there is a need for systems, apparatus, and methods that overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, an apparatus comprises: a computational memory controller configured to: receive a compute command from a processor; convert the compute command into a memory compute command; and transmit the memory compute command to a computational memory; the computational memory configured to: perform a mathematical operation using a plurality of operands of the memory compute command; and store a result of the mathematical operation in the computational memory.

In another aspect, an apparatus comprises: means for controlling configured to: receive a compute command from a processor; convert the compute command into a memory compute command; and transmit the memory compute command to means for computing and storing; the means for computing and storing configured to: perform a mathematical operation using a plurality of operands of the memory compute command; and store a result of the mathematical operation in the means for computing and storing.

In still another aspect, a method for converting a compute command, the method comprising: receiving, by a computational memory controller, the compute command from a processor; converting, by the computational memory controller, the compute command into a memory compute command; and transmitting, by the computational memory controller, the memory compute command to a computational memory; performing, by the computational memory, a mathematical operation using a plurality of operands of the memory compute command; and storing, by the computational memory, a result of the mathematical operation.

In still another aspect, a non-transitory computer-readable medium comprising instructions that when executed by a processor cause the processor to perform a method comprising: receiving, by a computational memory controller, the compute command from a processor; converting, by the computational memory controller, the compute command into a memory compute command; and transmitting, by the computational memory controller, the memory compute command to a computational memory; performing, by the computational memory, a mathematical operation using a plurality of operands of the memory compute command; and storing, by the computational memory, a result of the mathematical operation.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary processor system in accordance with some examples of the disclosure;

FIG. 2 illustrates an exemplary processor with memory compute drivers in accordance with some examples of the disclosure;

FIG. 3 illustrates exemplary compute command operations in accordance with some examples of the disclosure;

FIG. 4 illustrates exemplary memory compute command formats in accordance with some examples of the disclosure;

FIG. 5 illustrates an exemplary timing diagram in accordance with some examples of the disclosure;

FIG. 6 illustrates an exemplary access control system in accordance with some examples of the disclosure;

FIG. 7 illustrates exemplary memory compute controller in accordance with some examples of the disclosure;

FIG. 8 illustrates an exemplary partial method for converting a compute command in accordance with some examples of the disclosure;

FIG. 9 illustrates another exemplary partial method for converting a compute command in accordance with some examples of the disclosure;

FIG. 10 illustrates an exemplary mobile device in accordance with some examples of the disclosure; and

FIG. 11 illustrates various electronic devices that may be integrated with any of the aforementioned methods, devices, semiconductor devices, integrated circuits, die, interposers, packages, or package-on-packages (PoPs) in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs. In examples herein, computational operations (e.g., basic transform, math, and logical operations) may be performed by a computational memory, instead of a processor, within or near the computational memory in conjunction with a computational memory controller that may supervise the operations and protected the computational memory to prevent inter-process corruption, leakage, and/or security attacks without the use of conventional access permission filters. Examples herein may be used with digital memories and analog cell memories (e.g., DRAM, SRAM, NV-RAM, MRAM, etc.). In some examples, a compute command for an operation (e.g., vector, array, scalar, and logic operations) may be sent by a processor to a computational memory controller. The computational memory controller may convert the compute command into a memory compute command and transmit the memory compute command to a computational memory for processing. The computational memory may perform the mathematical operation using operands within the memory compute command and store the result in the computational memory and send an address for the result to the processor instead of the result itself.

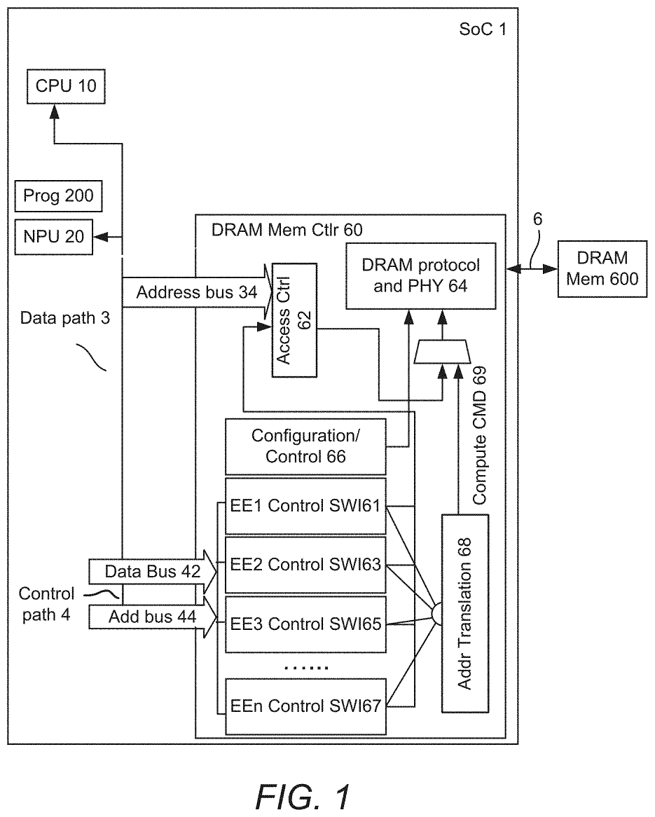

FIG. 1 illustrates an exemplary processor system in accordance with some examples of the disclosure. As shown in FIG. 1, a system on chip (SoC) 1 may comprises a computational memory controller 60 coupled to a computational memory 600 (e.g., DRAM memory) through a command and data bus 6 and to a processor 10 (e.g., CPU) through a data path 3 and a control path 4.

Those of ordinary skill in the art will appreciate that other data flows and connectivity configurations may also be implemented in accordance with other aspects or examples of the disclosure.

It should be understood that while a DRAM memory is shown, the memory 600 may also be another type of memory such as a memory that uses 1-bit per cell or an analog memory that uses more than 1-bit per cell. It should also be understood that while a CPU is shown, the processor 10 may also be another type of processor such as neural processor, graphics processor, or similar non-general processor. As shown in FIG. 1, a data bus 42 and an address bus 44 may be included in the control path 4 to allow access control on the control path 4. While the data bus 42 and the address bus 44 are illustrated as one example, it should be understood that other implementations are possible that allow a computational operation request to be intercepted and stopped when coming from the CPU 10.

Within the SoC 1, the target address of the request is not expressed on the address bus 34 of the data path 3, as conventionally done, but instead is on the address bus 44 of the control path 4. This target address may be translated using at least one of the software instance/item (SWI) groups 61-67 from data bus 42 to address translator 68. Translation may consist of simple copying of the target address from the control path into the data path. (Note that translation may involve first modifying the values of the target address and then using the modified target address in the data path. Changing the values of the target address may be performed when converting from a relative address to an absolute address, for example. In some examples, the computational memory 600 may be assumed to use absolute addressing, the host SoC 1 may provide the absolute addressing, and modifying values of the target address may not be performed). Then the address may be filtered/blocked via an access control 62.

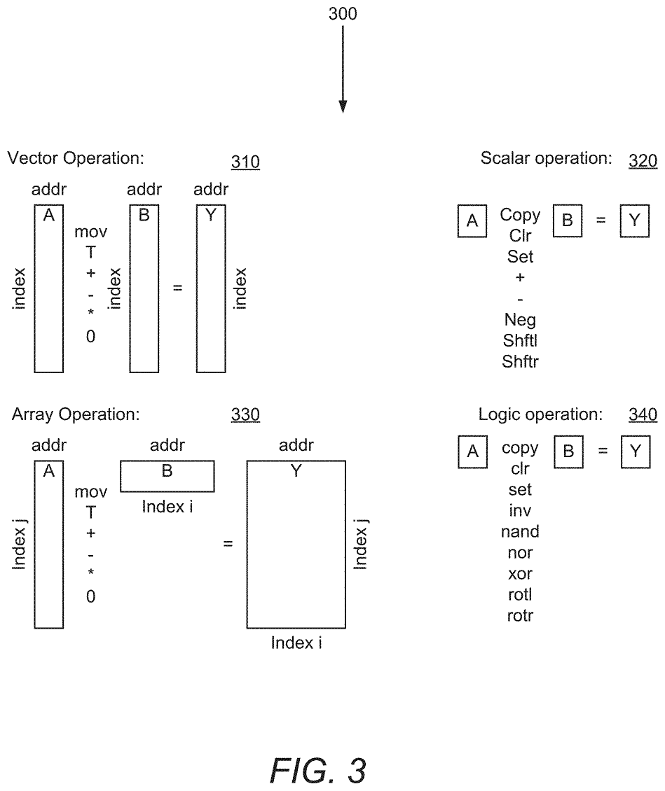

Address filtering/blocking may be done by determining the computational memory locations which will be affected (both inputs and output) and checking whether any of the memory locations are disallowed. If any portion of any input or any output included in the computational memory command resides at an address corresponding to a disallowed region of memory, then the command may be blocked. The compute command is converted into a memory compute command 69 at address translator 68. The memory compute command 69 may then be transmitted to the computational memory 600 wherein the operation (See FIG. 3, for examples) indicated in the opcode of the memory compute command 69 may be performed using the operands in the memory compute command 69 and the result may be stored in the computational memory 600. The address or location of the stored result in the computational memory 600 may be sent to the issuing processor (e.g., CPU 10).

As will be discussed in detail below, the computational memory controller 60 may also be configured to convert the memory compute command 69 into a set of address ranges and perform the memory compute command 69 when the set of address ranges is within a non-protected address range and an opcode in the compute command indicates a conventional compute command. In addition, the computational memory controller 60 may also be configured to perform the memory compute command 69 when the set of address ranges is within the non-protected address range and the opcode in the compute command indicates a non-conventional compute command. The computational memory controller 60 may also be configured to block the memory compute command 69 when the set of address ranges is within a protected address range and the opcode in the compute command indicates a conventional compute command and block the memory compute command 69 when the set of address ranges is within the protected address range and the opcode in the compute command indicates the non-conventional compute command. Also, the computational memory controller 60 may also be configured to perform the memory compute command 69 if the set of address ranges is valid, a processor ID in the compute command is an allowed ID, and an operation type is permitted. As an alternative, the computational memory controller 60 may also be configured to block the memory compute command 69 if one or more of the set of address ranges is not valid, the processor ID is a disallowed ID, or the operation type is not permitted. In these alternative configurations, the computational memory controller 60 may convert the compute command into the memory compute command 69 based on the opcode in the compute command. Furthermore, the memory compute command 69 may comprise an opcode (e.g., 8 bit), a start address (e.g., 48 bit), a size (e.g., 6 bit), and a precision level (e.g., 2 bit).

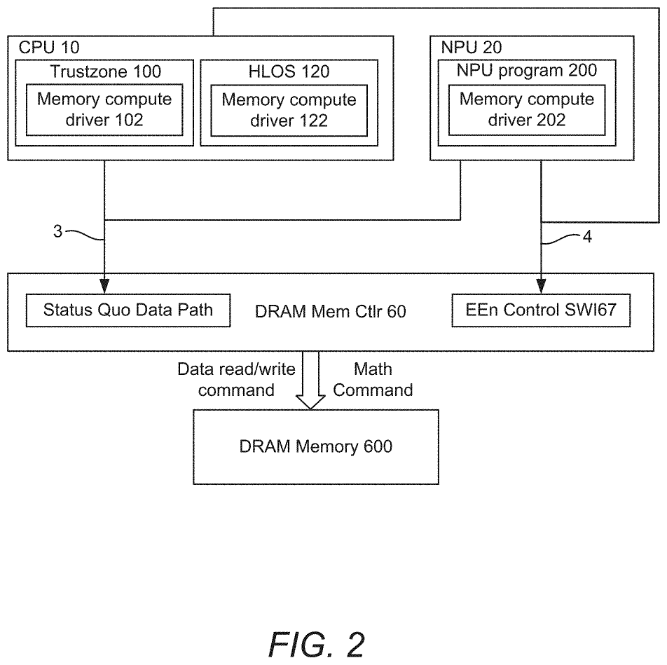

FIG. 2 illustrates an exemplary processor with memory compute drivers in accordance with some examples of the disclosure. As shown in FIG. 2, in some aspects the CPU 10 may include memory compute driver 102 and memory compute driver 122 while the NPU 20 may include memory compute driver 202. While two drivers are shown for CPU 10 and one driver is shown for NPU 20, it should be understood that SoC 1 may include one or more processors and the processors may include one or more compute drivers. The processor may send the processor command request (compute command) along the data path 3 (status quo data path) to the memory compute controller 60 or, if a memory compute command is indicated by the opcode in the processor command request, along the control path 4 to the memory compute controller 60 and SWI 67. Thus, the memory compute drivers may be coupled to the control path 4 to enable a memory compute command along the control path 4 instead of the conventional data path 3. The memory compute command may also be configured to generate the compute command in response to a compute request from the processor.

FIG. 3 illustrates exemplary compute command operations in accordance with some examples of the disclosure. As shown in FIG. 3, a compute command 300 may be a vector operation 310, a scalar operation 320, an array operation 330, or a logic operation 340. Each scalar, vector or array operation use a contiguous address range to represent by both a start address (48 bit) and size (16 bit) as well as point to the input variables A and B, and result Y. In some examples, the size=precision (2 bit), index i (6 bit), index j (6 bit), reserved (2 bit); precision={unsigned integer (unint) 8, unint 16, unint 32, integer (int) 32} such that, for example, an 8×8 array of int 32 will occupy 256 contiguous bytes of memory. Array operation 330 may, for example, compute a dot product multiplication operation of index j (array/column values for variable A stored at the specified address) and index i (array/row values for variable B stored at the specified address) to determine a result of index j by index i (array columns and rows for result Y stored the specified address). It should be understood that variations to these formats may be used with fundamental fields for operands and result. For example, “size” may be increased beyond 2 bytes, and include higher dimensional arrays such as a 3-dimensional array may be represented by including a third index k (6 bit) or other levels of precision such as unint 64 and int 64 may be represented by defining additional bits for precision.

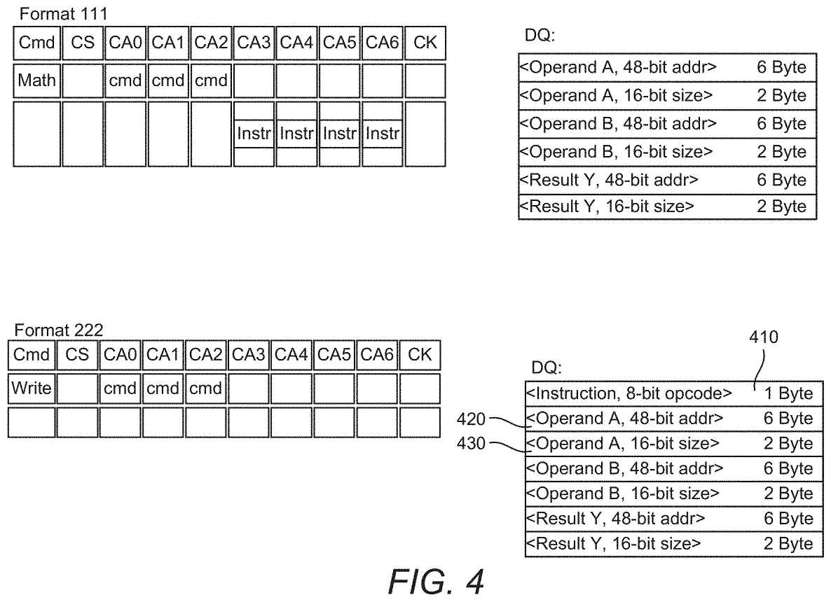

FIG. 4 illustrates exemplary memory compute command formats in accordance with some examples of the disclosure. As discussed above, the processor 10 in the SoC 1 may issue a compute command to the computational memory 600 in various ways. In one example, using format 222, the compute command includes an opcode 410 (e.g., 8 bit) to specify what type of math operation is to be performed; a start address 420 (e.g., 48 bit) and a size 430 (e.g., 16 bit) that points to input variable A (see also input variable B and result Y); a start address and size that points to input variable B; and a start address and size that points to the output result Y where the computational memory stores the computed value(s). In this example, the size 430 includes a precision (2 bit), an index i (6 bit), an index j (6 bit), reserved (2 bit), and the precision may include one of {unsigned int 8, unsigned int 16, unsigned int 32, int 32, for example}. In another example, using format 111, the compute command is instead a 4-bit opcode “INSTR” that is explicitly embedded within the command. As shown in FIG. 4, multiple types of formats are usable with the examples herein including format 111 for DRAM communications and format 222 for JEDEC compliant communications. Other communication formats are also possible, for example asynchronous SRAM interface, synchronous SRAM interface, etc. One advantage of allowing multiple formats is the ability to efficiently provide the memory compute command to the various memory types and convey the information including the opcode (INSTR), start address, index, and precision for each of the operands and the result.

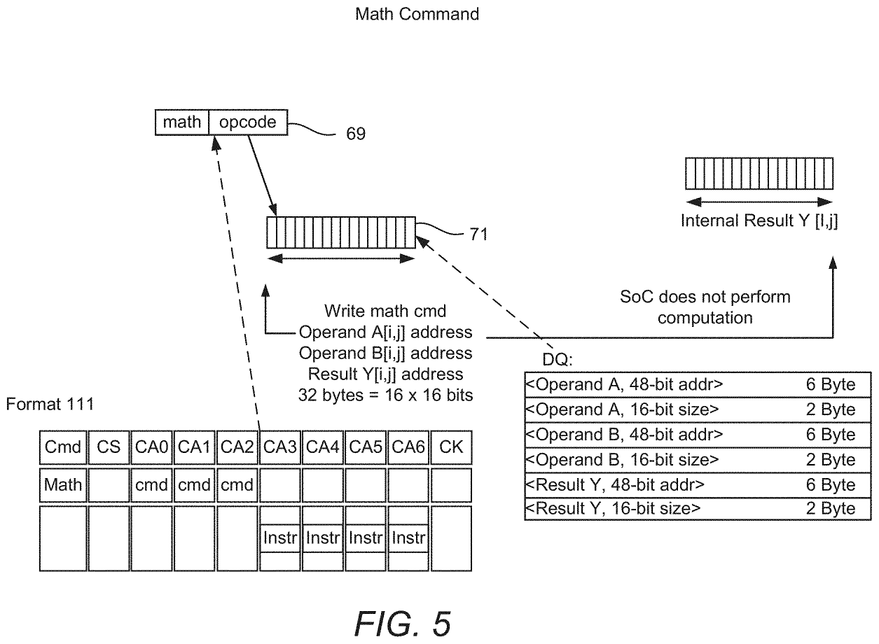

FIG. 5 illustrates an exemplary timing diagram in accordance with some examples of the disclosure. As shown in FIG. 5, a memory compute command 69 may include multiple addresses within the memory compute command structure as discussed above. The computational memory controller 60 may then be configured to convert the memory compute command 69 into a set of address ranges 71 including, for example, a 48-bit start address and a 16-bit size. The address ranges may be generated for each operand as well as the result. These address ranges, or other information in the memory compute command 69 (such as processor identification, numerical precision, and operand type) may be used to make block or no block decisions.

The block or no block decisions may include (a) when the set of address ranges is within a non-protected address range and an opcode in the compute command indicates a conventional compute command; (b) perform the memory compute command 69 when the set of address ranges is within the non-protected address range and the opcode in the compute command indicates a non-conventional compute command; (c) block the memory compute command 69 when the set of address ranges is within a protected address range and the opcode in the compute command indicates the conventional compute command; (d) block the memory compute command 69 when the set of address ranges is within the protected address range and the opcode in the compute command indicates the non-conventional compute command; (e) perform the memory compute command 69 if the set of address ranges is valid, a processor ID in the compute command is an allowed ID, and an operation type is permitted; and/or (0 block the memory compute command 69 if one or more of the set of address ranges is not valid, the processor ID is a disallowed ID, or the operation type is not permitted.

Setting protected and non-protected address ranges (such as in permission lists etc.) may be by the SoC 1 or processor 10 along with allowable processor identifications and may be stored in the SoC 1 or elsewhere. When the memory compute command is allowed, the command and information may be sent to the computational memory 600 for performing the indicated command operation. As such, only the addresses for the operands and result are communicated and not the actual values. The actual values stay within the computational memory until, for instance, the processor 10 may read the value of the result for further processing by a conventional read command targeting the address and size of the result Y. For example, if the computational command included a result Y that begins at address 0xFFFF0000 and has a size consisting of 32×32 unsigned int 8, then the entire array Y could be obtained by conventionally reading address 0xFFFF0000 through 0xFFFF03FF (i.e. read 1024 bytes beginning at decimal address 4294901760 and ending at decimal address 4294902783).

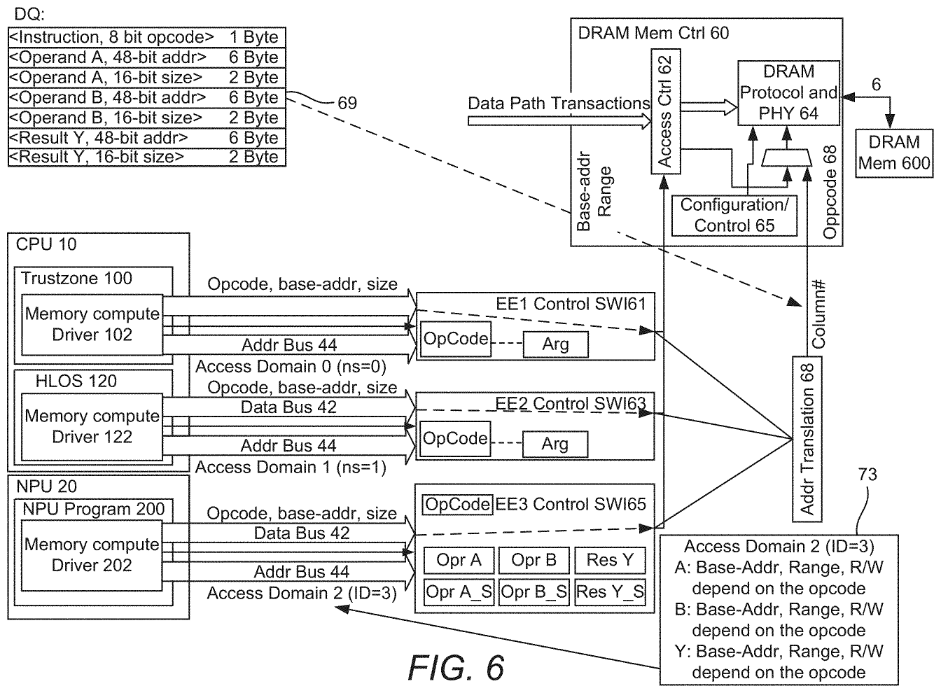

FIG. 6 illustrates an exemplary access control to block or not block in accordance with some examples of the disclosure. In conventional systems, the access control decisions may be enforced on the data path 3 to DRAM 600 by using the address bus as input to verify if the address is within a protected range or not together with other indications such as security domain indication (bus in TrustZone™, for example). In conventional systems, there is no path to access the DRAM 600 data beyond the data path 3. While a control path to a DRAM controller may exist in conventional systems, it is only to access the controller's configuration registers, such as clock frequency and not the address transaction permissions. In contrast, as shown in FIG. 6, memory compute driver 202, for example, may generate a compute command 73, transmit the compute command 73 over the control path 4 (i.e., data bus 42 and address bus 44) to the computational memory controller 60. As shown in FIG. 6, the compute command 73 may then be converted to a memory compute command 69 and transmit to the access control 62, for example, to make a block or no block decision based on the address ranges or other information such as processer ID (e.g., ID=3). If not blocked, the memory compute command 69 may be transmitted on memory bus 6 to the computational memory 600 for performing the indicated operation.

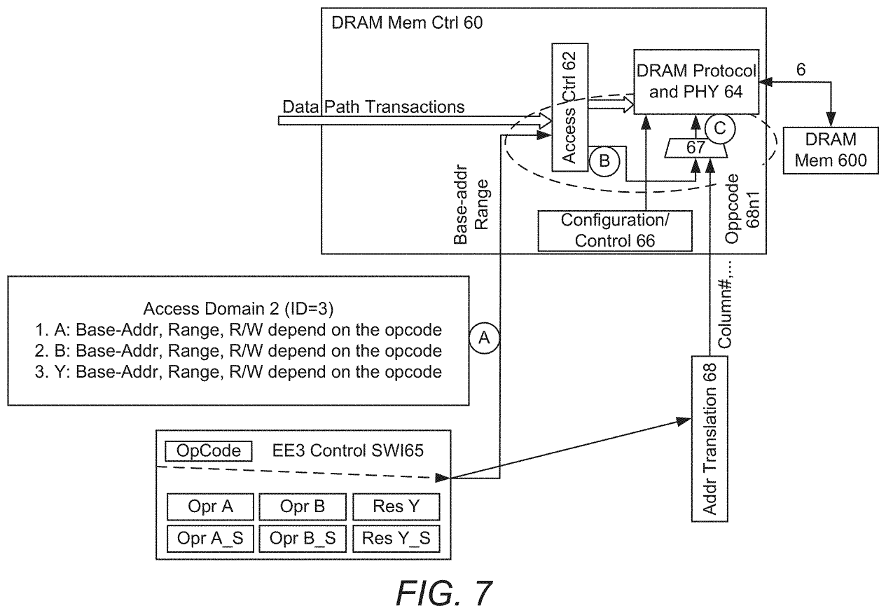

FIG. 7 illustrates another exemplary access control to block or not block in accordance with some examples of the disclosure. As shown in FIG. 7, the execution environment (EE) control block 61, EE control block 63, and EE control block 65 may be configured to inspect the incoming compute command 73 for the extracting relevant block or not information that may be transmitted to the address translator 68 to convert the compute command 73 to the memory compute command 69 as well as transmitted to the access control 62 to make the block or no block decisions.

As shown in FIG. 7, there could be multiple requests to access control 62 for one math opcode. In this example: (a) depending on the opcode, the number of access control requests could be 1, 2, or 3 for one math opcode; (b) as a result, each request to the access control 62 is aggregated and upon an access violation (e.g., protected range or unauthorized processor etc.), an indication is sent back to the requester (e.g., BUS_ERROR); and (c) if no access violation (decision to not block), then the aggregated request is sent to a control logic 67 to gate the opcode from being sent to a DRAM protocol and PHY 64.

The EE control block 65 may also be responsible for converting between size for the math command format and the range for access control check, such as:

$$size = precision ( 2 bit ) , index i ( 6 bit ) , index j ( 6 bit ) , reserved ( 2 bit ) ;$$

$$precision = \{ unint 8 , unint 16 , unint 32 , int 32 \} ; and$$

$$range = size . precision * size . index\_i * size . index\_j$$

If the size is extended to include additional precision or new operands, then the conversion calculation must also include these additional fields.

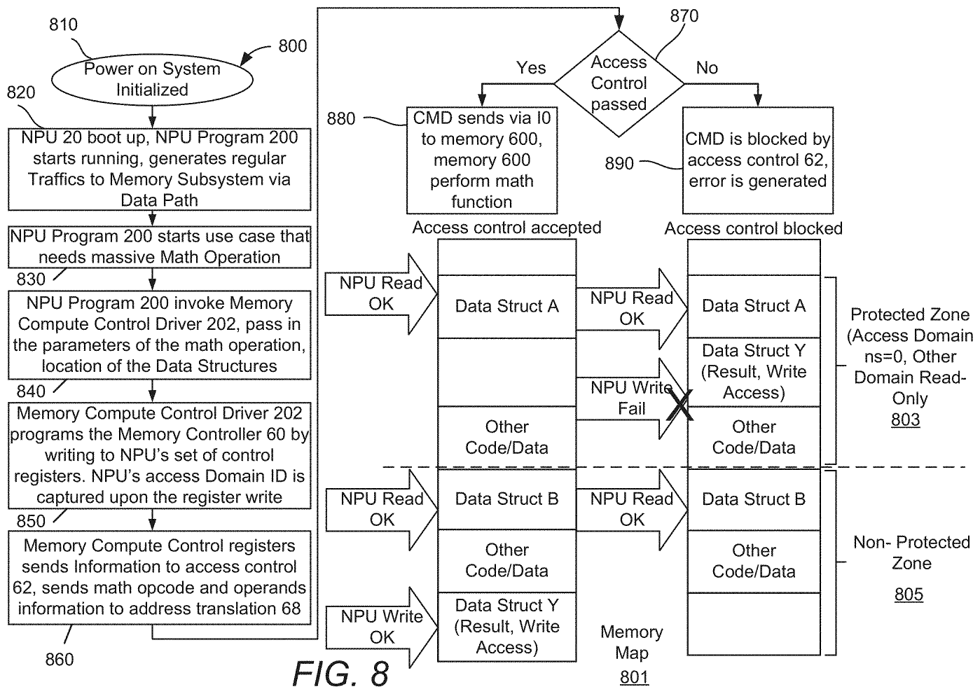

FIG. 8 illustrates an exemplary partial method for converting a compute command in accordance with some examples of the disclosure. As shown in FIG. 8, a physical memory map 801 of an EE control block with a protected zone 803 (e.g., protected from a write issued by NPU 20) and non-protected zone 805 is illustrated from a CPU or NPU point of view. As shown in FIG. 8, a partial process flow 800 may begin in block 810 with power on and system initialized. Next in block 820, the process continues with NPU 20 boot up, an NPU program 200 starts running, generates regular traffic to and from the memory subsystem via the data path 3 (See FIG. 1). Next in block 830, the process continues with NPU program 200 starting a use case that needs a permissive math operation to be performed. Next in block 840, the process continues with NPU program 200 invoking the memory compute control driver 202 and transmitting the parameters of the math operation and location of the data structures. Next in block 850, the process continues with the memory compute control driver 202 programing the memory controller 60 by writing to the NPU's 20 set of control registers (EE control block 65). NPU's access domain ID may be captured upon the register write. Next in block 860, the process continues with the EE control block 65 transmitting information to the access control 62 along with transmitting the math opcode and operand information to the address translation 68. Next in block 870, the process continues with a determination of whether the access control is passed or not (i.e., blocked or not). If a not block decision is made, then in block 880 the process continues with a memory compute command 69 transmitted to the computational memory 600 on memory bus 6 followed by the computational memory 600 performing the indicated math function (and storing the results as well as transmitting the address of the stored result to NPU 20). If a block decision is made, then in block 890 the process continues with the memory compute command 69 being blocked by access control 62 and generating an error message for transmission to NPU 20.

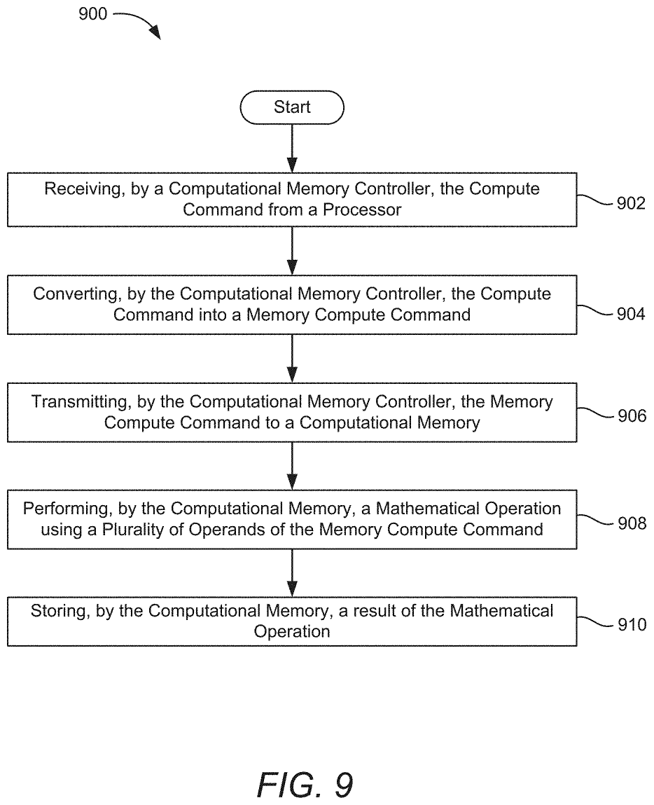

FIG. 9 illustrates an exemplary partial method for converting a compute command in accordance with some examples of the disclosure. As shown in FIG. 9, the partial method 900 may begin in block 902 with receiving, by a computational memory controller, the compute command from a processor. The partial method 900 may continue in block 904 with converting, by the computational memory controller, the compute command into a memory compute command. The partial method 900 may continue in block 906 with transmitting, by the computational memory controller, the memory compute command to a computational memory. The partial method 900 may continue in block 908 with performing, by the computational memory, a mathematical operation using a plurality of operands of the memory compute command. The partial method 900 may continue in block 910 with storing, by the computational memory, a result of the mathematical operation.

Alternatively, the partial method 900 may include (a) converting, by the computational memory controller, the memory compute command into a set of address ranges; (b) performing, by the computational memory controller, the memory compute command when the set of address ranges is within a non-protected address range and an opcode in the compute command indicates a conventional compute command; (c) performing, by the computational memory controller, the memory compute command when the set of address ranges is within the non-protected address range and the opcode in the compute command indicates a non-conventional compute command; (d) blocking, by the computational memory controller, the memory compute command when the set of address ranges is within a protected address range and the opcode in the compute command indicates the conventional compute command; and (e) blocking, by the computational memory controller, the memory compute command when the set of address ranges is within the protected address range and the opcode in the compute command indicates the non-conventional compute command.

In addition, the partial method may include (a) performing, by the computational memory controller, the memory compute command if the set of address ranges is valid, a processor ID in the compute command is an allowed ID, a numerical precision in the compute command is an allowed precision, and an operation type is permitted; (b) blocking, by the computational memory controller, the memory compute command if one or more of the set of address ranges is not valid, the processor ID is a disallowed ID, the numerical precision is a disallowed precision level, or the operation type is not permitted; (c) converting, by the computational memory controller, the compute command into the memory compute command based on the opcode in the compute command; (d) wherein the memory compute command comprises an opcode, a start address, a size, and a precision level; wherein the memory compute command comprises an opcode, a 48-bit start address, a 16-bit size, a 2-bit precision level; sending, by the computational memory controller, an address of the stored result to the processor without the result; generating, by a memory compute driver, the compute command; and (e) sending, by the memory compute driver, the compute command on a bus to the computational memory controller, wherein the bus is configured to couple the processor to the computational memory controller.

In addition, the partial method 900 may include incorporating the method (or at least one of the computational memory controller or computational memory) into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

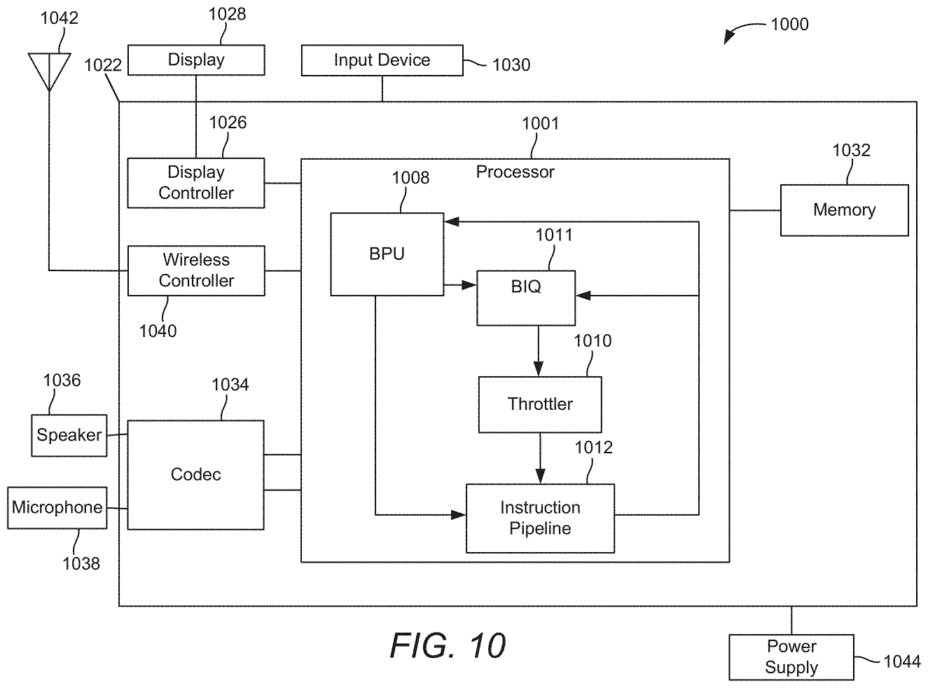

FIG. 10 illustrates an exemplary mobile device in accordance with some examples of the disclosure. Referring now to FIG. 10, a block diagram of a mobile device that is configured according to exemplary aspects is depicted and generally designated 1000. In some aspects, mobile device 1000 may be configured as a wireless communication device. As shown, mobile device 1000 includes processor 1001 (e.g., SoC 1), which may be configured to implement the methods described herein in some aspects. Processor 1001 is shown to comprise instruction pipeline 1012, buffer processing unit (BPU) 1008, branch instruction queue (BIQ) 1011, and throttler 1010 as is well known in the art. Other well-known details (e.g., counters, entries, confidence fields, weighted sum, comparator, etc.) of these blocks have been omitted from this view of processor 1001 for the sake of clarity.

Processor 1001 may be communicatively coupled to memory 1032 over a link, which may be a die-to-die or chip-to-chip link. Mobile device 1000 also include display 1028 and display controller 1026, with display controller 1026 coupled to processor 1001 and to display 1028.

In some aspects, FIG. 10 may include coder/decoder (CODEC) 1034 (e.g., an audio and/or voice CODEC) coupled to processor 1001; speaker 1036 and microphone 1038 coupled to CODEC 1034; and wireless controller 1040 (which may include a modem) coupled to wireless antenna 1042 and to processor 1001.

In a particular aspect, where one or more of the above-mentioned blocks are present, processor 1001, display controller 1026, memory 1032, CODEC 1034, and wireless controller 1040 can be included in a system-in-package or system-on-chip device 1022. Input device 1030 (e.g., physical or virtual keyboard), power supply 1044 (e.g., battery), display 1028, input device 1030, speaker 1036, microphone 1038, wireless antenna 1042, and power supply 1044 may be external to system-on-chip device 1022 and may be coupled to a component of system-on-chip device 1022, such as an interface or a controller.

It should be noted that although FIG. 10 depicts a mobile device, processor 1001 and memory 1032 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

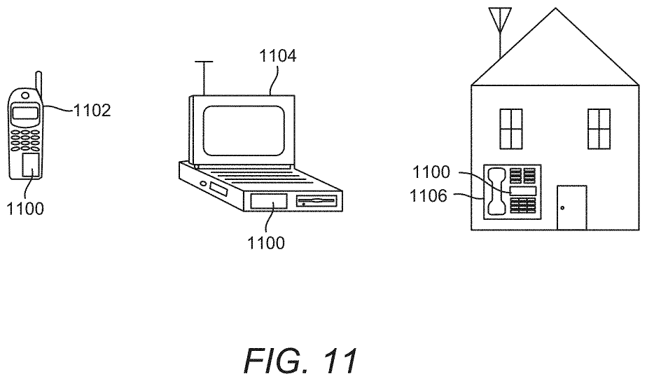

FIG. 11 illustrates various electronic devices that may be integrated with any of the aforementioned integrated device, semiconductor device, integrated circuit, die, interposer, package or package-on-package (PoP) in accordance with some examples of the disclosure. For example, a mobile phone device 1102, a laptop computer device 1104, and a fixed location terminal device 1106 may include an integrated device 1100 as described herein. The integrated device 1100 may be, for example, any of the integrated circuits, dies, integrated devices, integrated device packages, integrated circuit devices, device packages, integrated circuit (IC) packages, package-on-package devices described herein. The devices 1102, 1104, 1106 illustrated in FIG. 11 are merely exemplary. Other electronic devices may also feature the integrated device 1100 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

It will be appreciated that various aspects disclosed herein can be described as functional equivalents to the structures, materials and/or devices described and/or recognized by those skilled in the art. It should furthermore be noted that methods, systems, and apparatus disclosed in the description or in the claims can be implemented by a device comprising means for performing the respective actions of this method. For example, in one aspect, an apparatus may comprise means for controlling (e.g., computational memory controller) configured to: receive a compute command from a processor; convert the compute command into a memory compute command; and transmit the memory compute command to means for computing and storing (e.g., computational memory); the means for computing and storing configured to: perform a mathematical operation using a plurality of operands of the memory compute command; and store a result of the mathematical operation in the means for computing and storing. It will be appreciated that the aforementioned aspects are merely provided as examples and the various aspects claimed are not limited to the specific references and/or illustrations cited as examples.

One or more of the components, processes, features, and/or functions illustrated in FIGS. 1-11 may be rearranged and/or combined into a single component, process, feature or function or incorporated in several components, processes, or functions. Additional elements, components, processes, and/or functions may also be added without departing from the disclosure. It should also be noted that FIGS. 1-11 and its corresponding description in the present disclosure is not limited to dies and/or ICs. In some implementations, FIGS. 1-11 and its corresponding description may be used to manufacture, create, provide, and/or produce integrated devices. In some implementations, a device may include a die, an integrated device, a die package, an integrated circuit (IC), a device package, an integrated circuit (IC) package, a wafer, a semiconductor device, a package on package (PoP) device, and/or an interposer. An active side of a device, such as a die, is the part of the device that contains the active components of the device (e.g. transistors, resistors, capacitors, inductors etc.), which perform the operation or function of the device. The backside of a device is the side of the device opposite the active side.

As used herein, the terms “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms include, but are not limited to, a music player, a video player, an entertainment unit, a navigation device, a communications device, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that are able to communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of several types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to uplink/reverse or downlink/forward traffic channel.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE), Bluetooth (BT), Bluetooth Low Energy (BLE), IEEE 802.11 (WiFi), and IEEE 802.15.4 (Zigbee/Thread) or other protocols that may be used in a wireless communications network or a data communications network. Bluetooth Low Energy (also known as Bluetooth LE, BLE, and Bluetooth Smart) is a wireless personal area network technology designed and marketed by the Bluetooth Special Interest Group intended to provide considerably reduced power consumption and cost while maintaining a similar communication range. BLE was merged into the main Bluetooth standard in 2010 with the adoption of the Bluetooth Core Specification Version 4.0 and updated in Bluetooth 5 (both expressly incorporated herein in their entirety).

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

The various illustrative logical blocks, modules, and circuits described in connection with the aspects disclosed herein may be implemented or performed with a general purpose processor, a central processing unit (CPU), graphics processing unit (GPU), neural processing unit (NPU), system on Chip processing unit (SoC), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations). Additionally, these sequence of actions described herein can be considered to be incorporated entirely within any form of computer-readable storage medium (transitory and non-transitory) having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. An apparatus, comprising:
a computational memory controller configured to:
receive a compute command from a processor;
convert the compute command into a memory compute command; and
transmit the memory compute command to a computational memory; the computational memory configured to:
perform a mathematical operation using a plurality of operands of the memory compute command; and
store a result of the mathematical operation in the computational memory.

2. The apparatus of claim 1, wherein the computational memory controller is further configured to:
convert the memory compute command into a set of address ranges;
perform the memory compute command when the set of address ranges is within a non-protected address range and an opcode in the compute command indicates a conventional compute command; and
block the memory compute command when the set of address ranges is within a protected address range and the opcode in the compute command indicates the conventional compute command.

3. The apparatus of claim 1, wherein the computational memory controller is further configured to:
convert the memory compute command into a set of address ranges;
perform the memory compute command when the set of address ranges is within the non-protected address range and the opcode in the compute command indicates a non-conventional compute command; and
block the memory compute command when the set of address ranges is within the protected address range and the opcode in the compute command indicates the non-conventional compute command.

4. The apparatus of claim 1, wherein the computational memory controller is further configured to:
convert the memory compute command into a set of address ranges;
perform the memory compute command if the set of address ranges is valid, a processor ID in the compute command is an allowed ID, and an operation type is permitted; and
block the memory compute command if one or more of the set of address ranges is not valid, the processor ID is a disallowed ID, or the operation type is not permitted.

5. The apparatus of claim 1, wherein the computational memory controller converts the compute command into the memory compute command based on the opcode in the compute command and wherein the memory compute command comprises an opcode, a start address, a size, and a precision level.

6. The apparatus of claim 1, wherein the computational memory controller is further configured to send an address of the stored result to the processor without the result.

7. The apparatus of claim 1, further comprising:
a bus configured to couple the processor to the computational memory controller;
a memory compute driver;
wherein the memory compute driver is configured to:
generate the compute command; and
send the compute command on the bus to the computational memory controller.

8. The apparatus of claim 1, wherein the apparatus is incorporated into one of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

9. An apparatus, comprising:
means for controlling configured to:
receive a compute command from a processor;
convert the compute command into a memory compute command; and
transmit the memory compute command to means for computing and storing;
the means for computing and storing configured to:
perform a mathematical operation using a plurality of operands of the memory compute command; and
store a result of the mathematical operation in the means for computing and storing.

10. The apparatus of claim 9, wherein the means for controlling is further configured to:
convert the memory compute command into a set of address ranges;
perform the memory compute command when the set of address ranges is within a non-protected address range and an opcode in the compute command indicates a conventional compute command; and
block the memory compute command when the set of address ranges is within a protected address range and the opcode in the compute command indicates the conventional compute command.

11. The apparatus of claim 9, wherein the means for controlling is further configured to:
convert the memory compute command into a set of address ranges;
perform the memory compute command when the set of address ranges is within the non-protected address range and the opcode in the compute command indicates a non-conventional compute command; and
block the memory compute command when the set of address ranges is within the protected address range and the opcode in the compute command indicates the non-conventional compute command.

12. The apparatus of claim 9, wherein the means for controlling is further configured to:
convert the memory compute command into a set of address ranges;
perform the memory compute command if the set of address ranges is valid, a processor ID in the compute command is an allowed ID, and an operation type is permitted; and
block the memory compute command if one or more of the set of address ranges is not valid, the processor ID is a disallowed ID, or the operation type is not permitted.

13. The apparatus of claim 9, wherein the means for controlling converts the compute command into the memory compute command based on the opcode in the compute command and wherein the memory compute command comprises an opcode, a start address, a size, and a precision level.

14. The apparatus of claim 9, wherein the means for controlling is further configured to send an address of the stored result to the processor without the result.

15. The apparatus of claim 9, further comprising:
a bus configured to couple the processor to the means for controlling;
a memory compute driver;
wherein the memory compute driver is configured to:
generate the compute command; and
send the compute command on the bus to the means for controlling.

16. The apparatus of claim 9, wherein the apparatus is incorporated into one of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

17. A method for converting a compute command, the method comprising:
receiving, by a computational memory controller, the compute command from a processor;
converting, by the computational memory controller, the compute command into a memory compute command; and
transmitting, by the computational memory controller, the memory compute command to a computational memory;
performing, by the computational memory, a mathematical operation using a plurality of operands of the memory compute command; and
storing, by the computational memory, a result of the mathematical operation.

18. The method of claim 17, further comprising:
converting, by the computational memory controller, the memory compute command into a set of address ranges;
performing, by the computational memory controller, the memory compute command when the set of address ranges is within a non-protected address range and an opcode in the compute command indicates a conventional compute command; and
blocking, by the computational memory controller, the memory compute command when the set of address ranges is within a protected address range and the opcode in the compute command indicates the conventional compute command.

19. The method of claim 17, further comprising:
converting, by the computational memory controller, the memory compute command into a set of address ranges;
performing, by the computational memory controller, the memory compute command when the set of address ranges is within the non-protected address range and the opcode in the compute command indicates a non-conventional compute command; and
blocking, by the computational memory controller, the memory compute command when the set of address ranges is within the protected address range and the opcode in the compute command indicates the non-conventional compute command.

20. The method of claim 17, further comprising:
converting, by the computational memory controller, the memory compute command into a set of address ranges;
performing, by the computational memory controller, the memory compute command if the set of address ranges is valid, a processor ID in the compute command is an allowed ID, and an operation type is permitted; and
blocking, by the computational memory controller, the memory compute command if one or more of the set of address ranges is not valid, the processor ID is a disallowed ID, or the operation type is not permitted.

21. The method of claim 17, further comprising converting, by the computational memory controller, the compute command into the memory compute command based on the opcode in the compute command and wherein the memory compute command comprises an opcode, a start address, a size, and a precision level.

22. The method of claim 17, further comprising sending, by the computational memory controller, an address of the stored result to the processor without the result.

23. The method of claim 17, further comprising:
generating, by a memory compute driver, the compute command; and
sending, by the memory compute driver, the compute command on a bus to the computational memory controller, wherein the bus is configured to couple the processor to the computational memory controller.

24. The method of claim 17, wherein the method is incorporated into one of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

25. A non-transitory computer-readable medium comprising instructions that when executed by a processor cause the processor to perform a method comprising:
receiving, by a computational memory controller, the compute command from a processor;
converting, by the computational memory controller, the compute command into a memory compute command; and
transmitting, by the computational memory controller, the memory compute command to a computational memory;
performing, by the computational memory, a mathematical operation using a plurality of operands of the memory compute command; and
storing, by the computational memory, a result of the mathematical operation.

26. The non-transitory computer-readable medium of claim 25, wherein the method further comprises:
converting, by the computational memory controller, the memory compute command into a set of address ranges;
performing, by the computational memory controller, the memory compute command when the set of address ranges is within a non-protected address range and an opcode in the compute command indicates a conventional compute command; and
blocking, by the computational memory controller, the memory compute command when the set of address ranges is within a protected address range and the opcode in the compute command indicates the conventional compute command.

27. The non-transitory computer-readable medium of claim 25, wherein the method further comprises:
converting, by the computational memory controller, the memory compute command into a set of address ranges;
performing, by the computational memory controller, the memory compute command when the set of address ranges is within the non-protected address range and the opcode in the compute command indicates a non-conventional compute command; and
blocking, by the computational memory controller, the memory compute command when the set of address ranges is within the protected address range and the opcode in the compute command indicates the non-conventional compute command.

28. The non-transitory computer-readable medium of claim 25, wherein the method further comprises:
converting, by the computational memory controller, the memory compute command into a set of address ranges;
performing, by the computational memory controller, the memory compute command if the set of address ranges is valid, a processor ID in the compute command is an allowed ID, and an operation type is permitted; and
blocking, by the computational memory controller, the memory compute command if one or more of the set of address ranges is not valid, the processor ID is a disallowed ID, or the operation type is not permitted.

29. The non-transitory computer-readable medium of claim 25, wherein the method further comprises:
generating, by a memory compute driver, the compute command; and
sending, by the memory compute driver, the compute command on a bus to the computational memory controller, wherein the bus is configured to couple the processor to the computational memory controller.

30. The non-transitory computer-readable medium of claim 25, wherein the method is incorporated into one of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.
